(19) United States
(12) Patent Application Publication
(10) Pub. No.: US 2017/0167179 A1
(43) Pub. Date: Jun. 15, 2017

(54) METHOD OF CONTROLLING SLIDE DOOR AND VEHICLE SLIDE DOOR APPARATUS

(71) Applicant: Aisin Seiki Kabushiki Kaisha, Kariya-shi (JP)

(72) Inventors: Norikazu URATSUJI, Takahama-shi (JP); Miho Yarimizu, Nagoya-shi (JP); Takashi Kaino, Anjo-shi (JP)

(73) Assignee: Aisin Seiki Kabushiki Kaisha, Kariya-shi (JP)

(21) Appl. No.: 15/377,209

(22) Filed: Dec. 13, 2016

(30) Foreign Application Priority Data
Dec. 15, 2015 (JP) 2015-244331

(51) Int. Cl. E05F 15/73; B60J 5/06; E05F 15/60; B60N 2/00

(52) U.S. Cl. CPC E05F 15/73; B60N 2/002; B60J 5/062; E05F 15/60

(57) ABSTRACT

A method of controlling a slide door includes: detecting that a slide door of a vehicle is in an open state; detecting that an occupant sits at a seat in the vicinity of a door opening portion of the vehicle provided with the slide door; and moving the slide door such that a door handle provided in the slide door on a passenger compartment side of the vehicle is disposed at an operational standby position which is set to be located forward of a rear end position of a sitting surface of the seat in the vicinity of the door opening portion, if the slide door is in an open state, and the occupant sits at the seat in the vicinity of the door opening portion.

### CROSS REFERENCE TO RELATED APPLICATIONS

This application is based on and claims priority under 35 U.S.C. §119 to Japanese Patent Application 2015-244331, filed on Dec. 15, 2015, the entire contents of which are incorporated herein by reference.

### TECHNICAL FIELD

This disclosure relates to a method of controlling a slide door and a vehicle slide door apparatus.

### BACKGROUND DISCUSSION

There is a vehicle slide door apparatus in the related art which includes a drive source, estimates boarding and deboarding of a user, and automatically opens and closes a slide door. For example, a slide door apparatus disclosed in JP 2009-209659A (Reference 1) specifies a slide door which a user holding a portable device such as a so-called electronic key approaches, and automatically opens the slide door. The slide door apparatus is configured to automatically close the open slide door after detecting that the user boards a vehicle.

A timing when a door is assumed to be closed by a user is not necessarily constant. If a configuration in which a slide door is automatically fully closed is adopted, there is a high possibility of so-called jamming occurring. For this reason, the closing of a slide door is desirably performed by a user as in the related art.

In contrast, as illustrated in FIG. 12, there is a possibility that an inside door handle 93 provided in a slide door 92 is disposed rearward of an occupant 95 sitting at a seat 94 in the vicinity of a large door opening portion 90 in a vehicle 91 including the door opening portion 90. There is a problem in that when the occupant 95 intends to operate the slide door 92 in this state, the occupant 95 is placed in an awkward posture in which the occupant 95 twists the upper body and stretches the hand rearward. Therefore, there is room for improvement in this regard.

### SUMMARY

Thus, a need exists for a method of controlling a slide door and a vehicle slide door apparatus which is not suspectable to the drawback mentioned above.

It is preferable that a method of controlling a slide door according to an aspect of this disclosure includes: detecting that a slide door of a vehicle is in an open state; detecting that an occupant sits at a seat in the vicinity of a door opening portion of the vehicle provided with the slide door; and moving the slide door such that a door handle provided in the slide door on a passenger compartment side of the vehicle is disposed at an operational standby position which is set to be located forward of a rear end position of a sitting surface of the seat in the vicinity of the door opening portion, if the slide door is in an open state, and the occupant sits at the seat in the vicinity of the door opening portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block diagram illustrating a schematic configuration of a slide door apparatus;

FIG. 2 is a view illustrating a slide door provided in a door opening portion of a vehicle, and a seat forming a seat in the vicinity of the door opening portion (fully open position and an occupant not illustrated);

FIG. 3 is a flowchart illustrating the sequence of a process of operational standby position movement control;

FIG. 4 is a view illustrating the slide door provided in the door opening portion of the vehicle, and the seat forming the seat in the vicinity of the door opening portion (operational standby position and when an occupant sits at the seat);

FIG. 5 is a view illustrating an occupant who operates door handle of the slide door in a state where the occupant sits at the seat in the vicinity of the door opening portion (operational standby position);

FIG. 6 is a flowchart illustrating the sequence of a process of setting the operational standby position based on detection of the center of gravity of the occupant;

FIG. 7 is a flowchart illustrating the sequence of a process of correcting the operational standby position based on detection of the physique of the occupant;

FIG. 8 is a flowchart illustrating the sequence of a process of setting the operational standby position in another example;

FIG. 9 is a view illustrating a mode of the operational standby position movement control using a door side marker and a seat side marker;

FIG. 10 is a flowchart illustrating the sequence of a process of controlling re-movement of the slide door in correspondence with a change in sitting position;

FIG. 11 is a flowchart illustrating the sequence of a process of fully closing control based on detection (estimation) of an operational posture; and

FIG. 12 is a view (fully open position) illustrating an occupant who operates the door handle of the slide door in a state where the occupant sits at the seat in the vicinity of the door opening portion.

### DETAILED DESCRIPTION

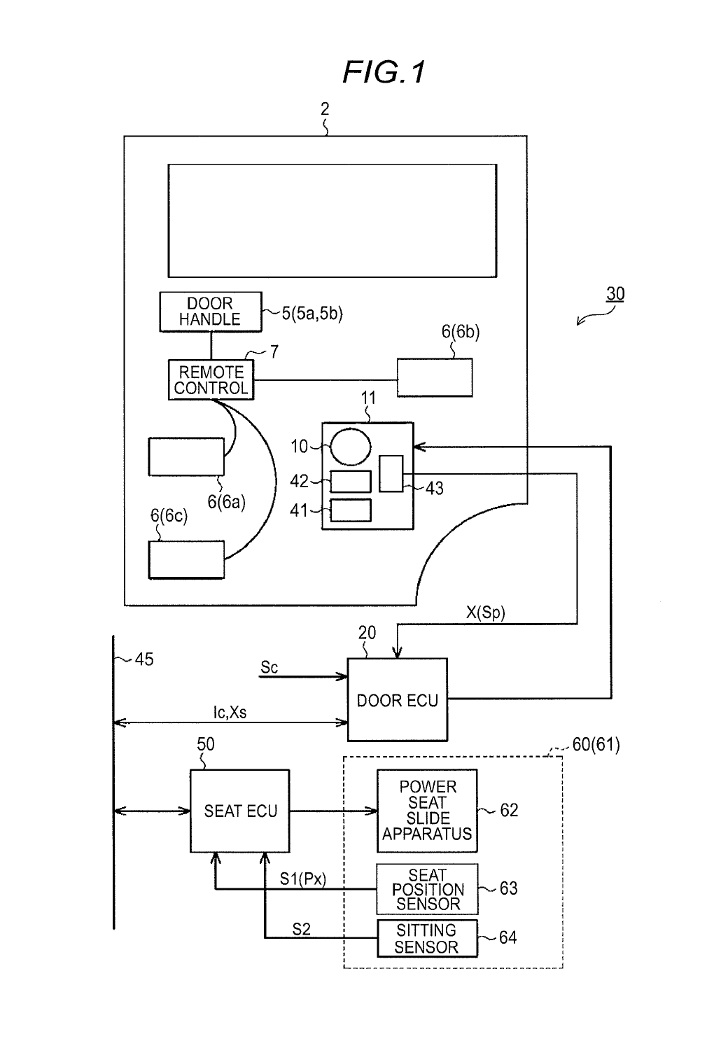

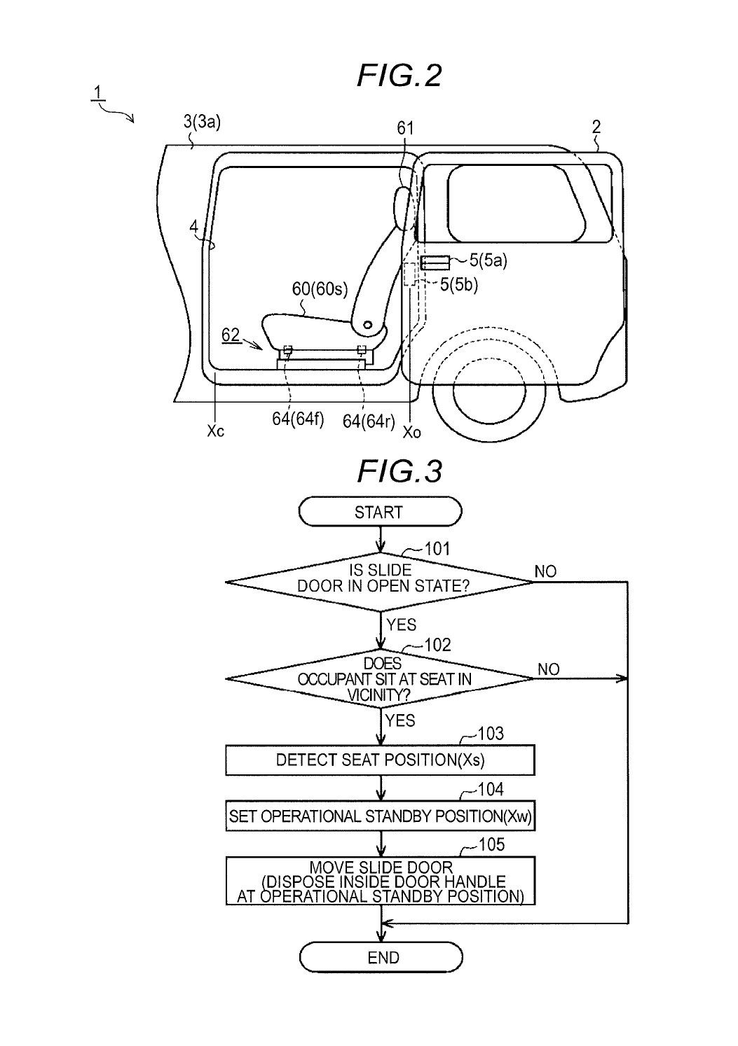

Hereinafter, a method of controlling a slide door and a vehicle slide door apparatus in an embodiment will be described with reference to the accompanying drawings. As illustrated in FIGS. 1 and 2, a slide door 2 of a vehicle 1 opens and closes a door opening portion 4 provided in a lateral surface 3a of a vehicle body 3 by being moved in a forward and rearward direction while being supported by the lateral surface 3a of the vehicle body 3. Specifically, the slide door 2 is configured such that if the slide door 2 is moved to a front side (left side in the drawings) of the vehicle, the slide door 2 enters a fully closed state in which the door opening portion 4 is blocked, and if the slide door 2 is moved to a rear side (right side in the drawings) of the vehicle, the slide door 2 enters a fully open state in which an occupant can board and deboard the vehicle via the door opening portion 4. The slide door 2 is provided with a door handle 5 for opening and closing the slide door 2.

As illustrated in FIG. 1, the slide door 2 is provided with multiple lock devices 6 including a well-known latch mechanism that engages with a striker (not illustrated) provided on a vehicle body 3 side in correspondence with the movement position of the slide door 2. Specifically, the slide door 2 is provided with a front lock 6a which is a fully closed lock holding the slide door 2 at a fully closed position, and a rear lock 6b. The slide door 2 is further provided with a fully open lock 6c that holds the slide door 2 at a fully open position. The lock devices 6 are connected to the door handle 5 via a remote control 7.

That is, if the door handle 5, specifically, either an outside door handle 5a provided on the outside of the vehicle 1 or an inside door handle 5b provided on a passenger compartment side of the vehicle 1 is operated, a locked state of the slide door 2 of the embodiment enabled by the lock devices 6 is released. Even if an occupant operates an operation switch provided in a passenger compartment or an operation input unit of a portable device or the like, a locked state of the slide door 2 enabled by the lock devices 6 can be released. The slide door 2 of the embodiment is configured such that the door handle 5 serves as a grip unit when the slide door 2 is opened and closed.

The slide door 2 of the embodiment is provided with a drive device 11 including a motor 10 as a drive source. The operation of the drive device 11 is controlled by a door ECU 20. As a result, a slide door apparatus 30 of the embodiment capable of opening and closing the slide door 2 using a driving force of the motor 10 is formed.

Specifically, the drive device 11 of the embodiment includes an opening and closing drive unit 41 that drives the opening and closing of the slide door 2 using a driving force of the motor 10 via a drive cable (not illustrated). The drive device 11 is provided with an electromagnetic clutch 42 capable of connecting and disconnecting a driving force of the motor 10 which is transmitted to the slide door 2 via the opening and closing drive unit 41. Specifically, the electromagnetic clutch 42 is configured such that the electromagnetic clutch 42 is turned on if energized, and a torque transmission path is connected between the motor 10 and the opening and closing drive unit 41. The slide door apparatus 30 of the embodiment is configured such that the slide door 2 is smoothly opened and closed even by a manual operation in which drive control of the motor 10 is not performed.

More specifically, the door ECU 20 of the embodiment is configured to receive an operation input signal Sc indicating that the door handle 5 or other operation input units are operated to open and close the slide door 2. That is, the door ECU 20 of the embodiment detects a user's demand for the operation of the slide door 2 based on the operation input signal Sc. The operation of the drive device 11 is controlled such that the slide door 2 is moved in an opening and closing direction indicated by the operation demand.

Specifically, the drive device 11 of the embodiment is provided with a pulse sensor 43 that outputs pulse signals Sp in synchronization with the operation of the opening and closing drive unit 41. The door ECU 20 of the embodiment is configured to execute opening drive control and closing drive control for the slide door 2 based on a movement position X of the slide door 2 which is detected by counting up the pulse signals Sp.

The door ECU 20 of the embodiment is connected to a seat ECU 50 via an on-board network 45. Seat information acquired from the seat ECU 50 is used for controlling the driving of the slide door 2.

Specifically, as illustrated in FIGS. 1 and 2, in the vehicle 1 of the embodiment, a seat 61 forming a seat 60 in the vicinity of the door opening portion 4 of the vehicle 1 provided with the slide door 2 is provided with a power seat slide apparatus 62 including a motor (not illustrated) as a drive source. In the vehicle 1 of the embodiment, the seat 60 in the vicinity of the door opening portion 4 is a rear seat (second row seat). The seat ECU 50 is configured to adjust a forward and rearward position (slide position) of the seat 61 by controlling the operation of the power seat slide apparatus 62.

The seat ECU 50 detects a slide position Px of the seat 61 based on an output signal S1 of a seat position sensor 63 provided in the seat 61. The seat ECU 50 executes an occupant detection determination as to whether an occupant sits at the seat 61, based on an output signal S2 of a sitting sensor 64 provided in the seat 61. In the embodiment, weight sensors 64f and 64r capable of respectively detecting front and rear weights (Wf and Wr) of the seat 61 are used as the sitting sensor 64. The door ECU 20 of the embodiment is configured to acquire the slide position Px of the seat 61 forming the seat 60 in the vicinity of the door opening portion 4 of the vehicle 1 provided with the slide door 2, and occupant detection information Ic which are seat information by communicating with the seat ECU 50 via the on-board network 45.

Specifically, as illustrated in the flowchart of FIG. 3, if the slide door 2 is in an open state (Step S101: YES), the door ECU 20 of the embodiment determines whether the occupant sits at the seat 60 in the vicinity of the door opening portion 4 of the vehicle 1 provided with the slide door 2, based on the occupant detection information Ic acquired from the seat ECU 50 (Step S102). If the slide door 2 is in an open state, and the occupant sits at the seat 60 in the vicinity of the door opening portion 4 (Step S101: YES, and Step S102: YES), the door ECU 20 is configured to move the slide door 2 forward from a fully open position Xo (Steps S103 to S105).

Specifically, the door ECU 20 of the embodiment detects a seat position Xs in the vicinity of the door opening portion 4 at which the occupant sits by converting the slide position Px of the seat 61, which is acquired from the seat ECU 50, into the movement position X of the slide door 2 with respect to the fully open position Xo (X=0) of the slide door 2 (Step S103). Subsequently, the door ECU 20 sets an operational standby position Xw which is a target position in controlling the driving of the slide door 2, based on the seat position Xs in the vicinity of the door opening portion 4 at which the occupant sits (Step S104). The door ECU 20 of the embodiment is configured to move the slide door 2 such that the inside door handle 5b is disposed at the operational standby position Xw (Step S105).

More specifically, as illustrated in FIG. 4, the door ECU 20 of the embodiment detects a front end position Xf and a rear end position Xr of a sitting surface 60s of the seat 60 as the seat position Xs in the vicinity of the door opening portion 4 at which an occupant 70 sits. In FIGS. 2 and 4, for purpose of illustration, the movement position X (Xo, Xc, and Xw) of the slide door 2 represents the position of disposition of the inside door handle 5b. The door ECU 20 is configured to set a predetermined position X1 between the front end position Xf and the rear end position Xr of the sitting surface 60s to the operational standby position Xw at which the inside door handle 5b is disposed.

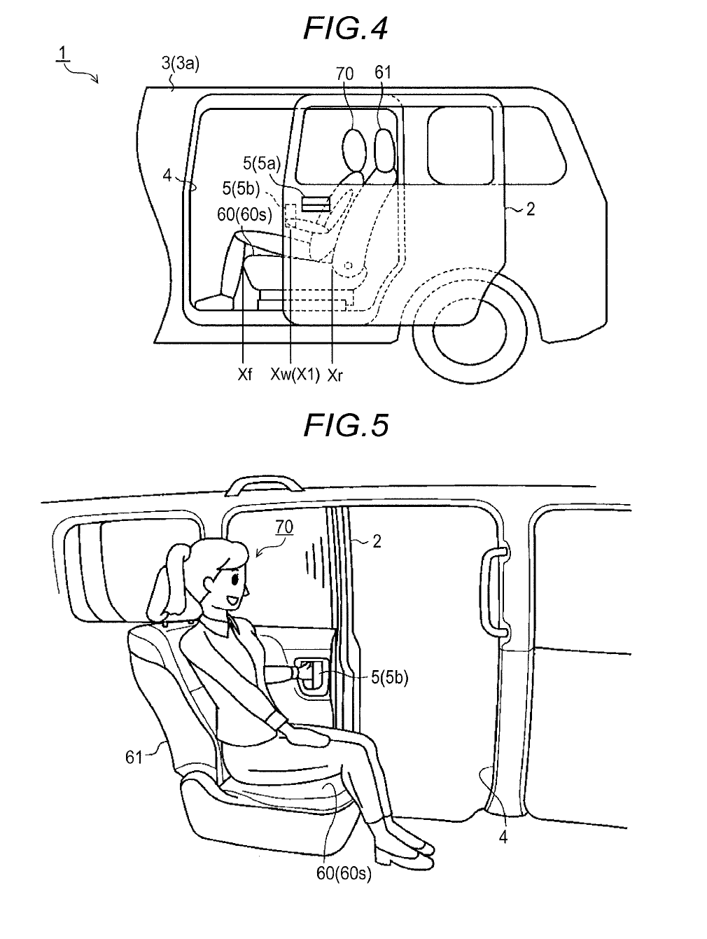

That is, as illustrated in FIGS. 4 and 5, if the inside door handle 5b is positioned forward of the upper body of the occupant 70 when the occupant 70 sitting at the seat 60 in the vicinity of the door opening portion 4 intends to operate the inside door handle 5b, the occupant 70 can stretch the hand to the inside door handle 5b without twisting the upper body.

From this perspective, if the occupant 70 having a standard physique sits at the seat 61 forming the seat 60 in the vicinity of the door opening portion 4, the slide door apparatus 30 of the embodiment presets a position, which is spaced a predetermined distance (for example, 70 mm to 80 mm) forward of a hip point of the occupant 70, to the predetermined position X1 between the front end position Xf and the rear end position Xr. The slide door apparatus 30 of the embodiment is configured to set the predetermined position X1 as the operational standby position Xw, and to move the slide door 2 to the operational standby position Xw such that the inside door handle 5b is disposed at the operational standby position Xw. As a result, the occupant 70 sitting at the seat 60 in the vicinity of the door opening portion 4 can easily operate the slide door 2 without modifying a sitting posture.

According to the embodiment, it is possible to obtain the following effects. (1) The door ECU 20 serving as a door open state detection unit and a sitting detection unit detects that the slide door 2 is in an open state, and that the occupant 70 sits at the seat 60 in the vicinity of the door opening portion 4 of the vehicle 1 provided with the slide door 2. If the slide door 2 is in an open state, and it is detected that the occupant 70 sits at the seat 60 in the vicinity of the door opening portion 4, the door ECU 20 serving as a movement control unit sets the operational standby position Xw to be located forward of the rear end position Xr of the sitting surface 60s of the seat 60 in the vicinity of the door opening portion 4. The slide door 2 is moved such that the inside door handle 5b is disposed at the operational standby position Xw.

In this configuration, it is possible to dispose the inside door handle 5b of the slide door 2 forward of the upper body of the occupant 70 sitting at the seat 60 in the vicinity of the door opening portion 4. As a result, the occupant 70 can stretch the hand to the inside door handle 5b without twisting the upper body. Accordingly, the occupant 70 can easily operate the slide door 2.

(2) The operational standby position Xw is set to be located rearward of the front end position Xf of the sitting surface 60s. Accordingly, the occupant 70 sitting at the seat 60 in the vicinity of the door opening portion 4 can easily operate the slide door 2 while maintaining a sitting posture.

The embodiment may be changed in the following manner. In the embodiment, the seat 60 in the vicinity of the door opening portion 4 is a rear seat (second row seat) of the vehicle 1. However, this disclosure is not limited to that configuration. It may be possible to embody a configuration in which the seat 60 in the vicinity of the door opening portion 4 of the vehicle 1 provided with the slide door 2 is a front seat (first row seat) of the vehicle.

In the embodiment, the operational standby position Xw at which the inside door handle 5b of the slide door 2 is to be disposed is set to the predetermined position X1 that is preset between the front end position Xf and the rear end position Xr of the sitting surface 60s of the seat 60 in the vicinity of the door opening portion 4. However, this disclosure is not limited to that configuration. For example, a position Xg of the center of gravity of the occupant 70 sitting at the seat 60 in the vicinity of the door opening portion 4 is detected. The operational standby position Xw may be set based on the position Xg of the center of gravity.

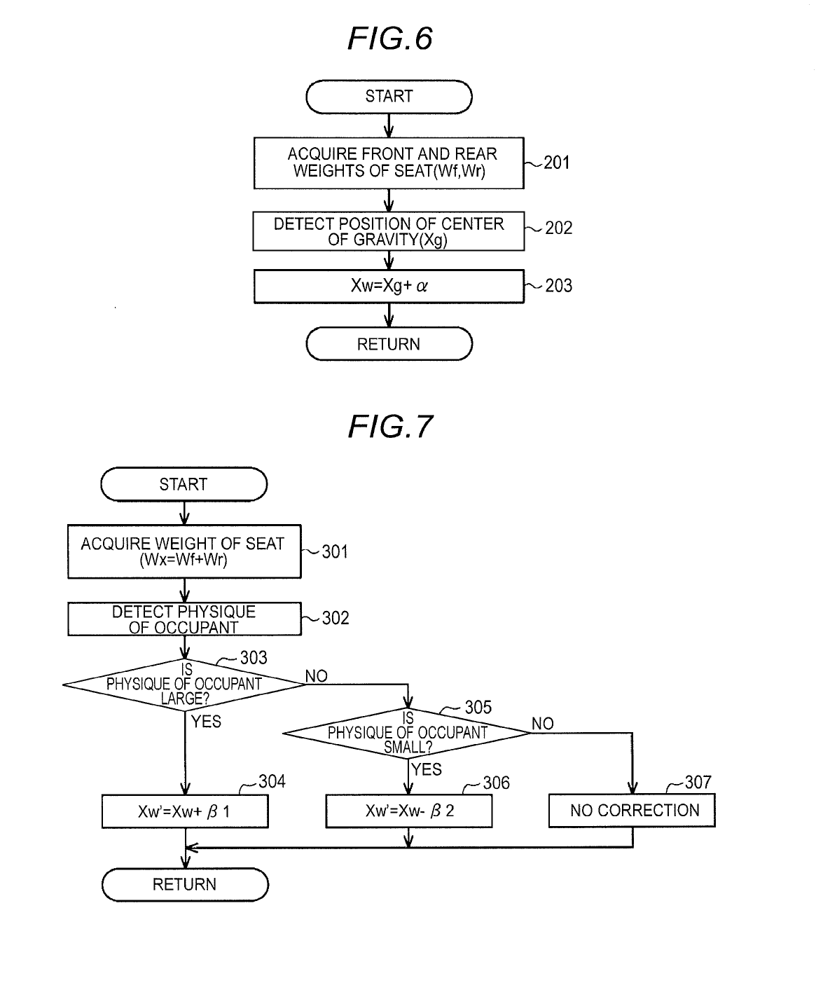

For example, as illustrated in the flowchart of FIG. 6, if the weight sensors 64f and 64r capable of respectively detecting the front weight Wf and the rear weight Wr of the seat 61 are used as the sitting sensor 64 of the seat 61 forming the seat 60 in the vicinity of the door opening portion 4, the door ECU 20 acquires the front weight Wf and the rear weight Wr from the seat ECU 50 (Step S201). The door ECU 20 serving as a center-of-gravity detection unit detects the position Xg of the center of gravity in the forward and rearward direction of the vehicle based on a ratio between the front weight Wf and the rear weight Wr (Step S202). That is, the position Xg of the center of gravity is detected based on a distribution of loads applied to the sitting surface of the seat.

A step of detecting the position Xg of the center of gravity may be arbitrarily changed, for example, the position Xg of the center of gravity may be obtained from a pressure distribution of the sitting surface 60s. A predetermined value a may be added to the position Xg of the center of gravity such that the operational standby position Xw is set to be located forward of the position Xg of the center of gravity (Xw=Xg+α) (Step S203).

That is, it is possible to estimate the position (for example, position which is spaced 70 mm to 80 mm from the hip point of the occupant 70) of the inside door handle 5b to which the occupant 70 sitting at the seat 60 in the vicinity of the door opening portion 4 easily stretches the hand, based on the detected position Xg of the center of gravity. If the operational standby position Xw is set to the estimated position, the occupant 70 can more easily operate the slide door 2.

As illustrated in the flowchart of FIG. 7, the door ECU 20 serving as a physique detection unit detects the physique of the occupant 70 sitting at the seat 60 in the vicinity of the door opening portion 4 of the vehicle 1 provided with the slide door 2 (Step S302), by acquiring a seat weight Wx from the seat ECU 50 (Wx=Wf+Wr) (Step S301). That is, it is possible to estimate that the physique is large to the extent that the weight of the occupant 70 represented by the detected seat weight Wx is heavy. The physique of the occupant 70 may be estimated by the seat ECU 50. The door ECU 20 serving as an operational standby position correction unit may be configured to correct the operational standby position Xw at which the inside door handle 5b of the slide door 2 is to be disposed, based on the detected physique of the occupant 70 (Steps S303 to S307).

Specifically, if the physique of the occupant 70 sitting at the seat 60 in the vicinity of the door opening portion 4 is large (Step S303: YES), the door ECU 20 corrects the operational standby position Xw to a forward position by adding a predetermined value β1 to the operational standby position Xw that is preset (Xw′=Xw+β1) (Step S304). If the physique of the occupant 70 is small (Step S305: YES), the door ECU 20 corrects the operational standby position Xw to a rearward position by subtracting a predetermined value β2 from the operational standby position Xw that is preset (Xw′=Xw−β2) (Step S306). If the physique of the occupant 70 is neither large nor small (Step S305: NO), that is, if the occupant 70 has a standard physique, the door ECU 20 does not correct the operational standby position Xw that is preset (Step S307).

As such, the operational standby position Xw may be corrected to a forward position for the inside door handle 5b to be disposed at a position which is moved forward to the extent that the physique of the occupant 70 sitting at the seat 60 in the vicinity of the door opening portion 4 of the vehicle 1 provided with the slide door 2 is large. Accordingly, in correspondence with the physique of the occupant 70, it is possible to dispose the inside door handle 5b at a position to which the occupant 70 more easily stretches the hand. As a result, the occupant 70 can more easily operate the slide door 2.

In the example illustrated in the flowchart of FIG. 7, the physique of the occupant 70 sitting at the seat 60 in the vicinity of the door opening portion 4 is detected (estimated) based on the seat weight Wx which is detected by the weight sensors 64f and 64r provided in the seat 61. However, this disclosure is not limited to that configuration. The configuration in which the physique of the occupant 70 is detected may be arbitrarily changed, for example, the physique of the occupant 70 may be detected via image analysis using a camera.

In the embodiment, the power seat slide apparatus 62 is provided in the seat 61 forming the seat 60 in the vicinity of the door opening portion 4 of the vehicle 1 provided with the slide door 2. However, this disclosure is not limited to that configuration. The slide position Px (seat position Xs) of the seat 61 may be manually changeable.

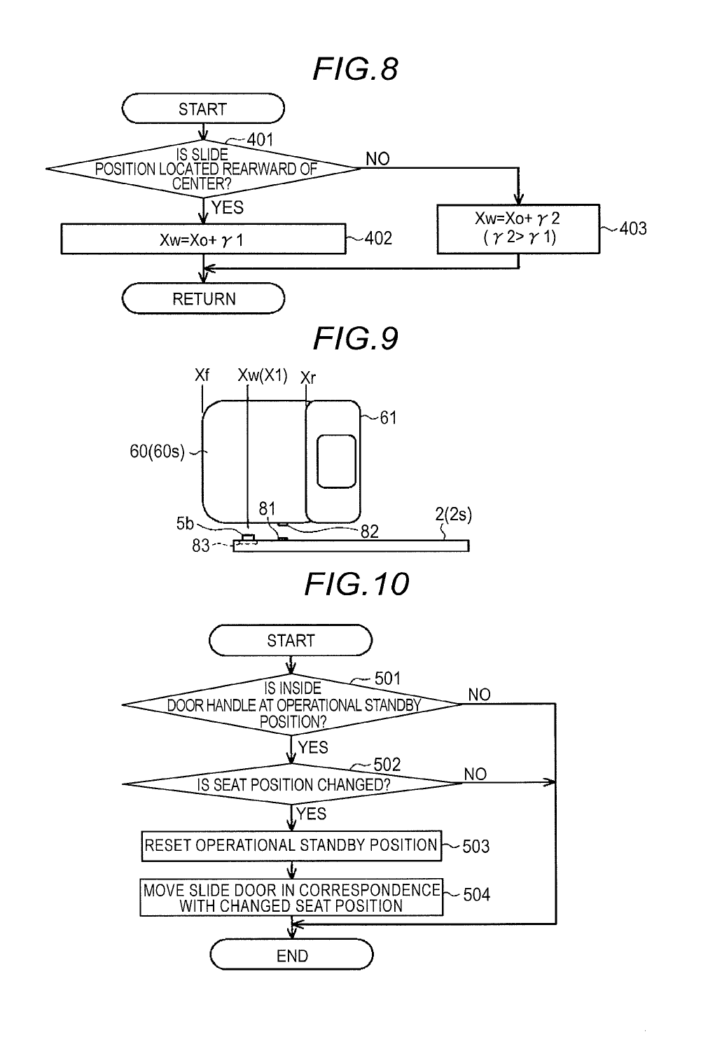

For example, as illustrated in the flowchart of FIG. 8, the operational standby position Xw at which the inside door handle 5b of the slide door 2 is to be disposed may be switched based on whether the slide position Px of the seat 61 forming the seat 60 in the vicinity of the door opening portion 4 is located rearward of a central position of a range in which the slide position Px can be adjusted in the forward and rearward direction.

Specifically, in this example, if the slide position Px of the seat 61 is located rearward of the central position (Step S401: YES), the door ECU 20 sets the operational standby position Xw by adding a predetermined value yl to the fully open position Xo of the slide door 2, which is a reference (X=0) of the movement position X (Xw=Xo+γ1) (Step S402). If the slide position Px of the seat 61 is located forward of the central position (Step S401: NO), the door ECU 20 sets the operational standby position Xw by adding a predetermined value γ2 (greater than the predetermined value γ1) to the fully open position Xo of the slide door 2 (Xw=Xo+γ2 and γ2>γ1) (Step S403).

In this configuration, it is also possible to dispose the inside door handle 5b at a position to which the occupant 70 sitting at the seat 60 in the vicinity of the door opening portion 4 easily stretches the hand. Accordingly, the occupant 70 can easily operate the slide door 2.

In the example illustrated in the flowchart of FIG. 8, the operational standby position Xw may be set in two stages in correspondence with the slide position Px of the seat 61. Alternatively, the operational standby position Xw may be set in three or more stages. The aforementioned description is also applied to a configuration in which the operational standby position Xw is set to be located forward of the front end position Xf of the sitting surface 60s.

In the embodiment, the door ECU 20 detects the seat position Xs in the vicinity of the door opening portion 4 at which the occupant 70 sits, based on the slide position Px of the seat 61 acquired from the seat ECU 50 (refer to FIG. 3) (Step S103). However, this disclosure is not limited to that configuration. If the slide door 2 can be moved such that the inside door handle 5b is disposed at the operational standby position Xw which is set, the seat position Xs may not necessarily be directly detected.

For example, as illustrated in FIG. 9, a door side marker (second marker) 81 is provided on an inside surface 2s of the slide door 2, and a seat side marker (first marker) 82 is provided at a position on the outside (lower side in FIG. 9) of the seat 61, which forms the seat 60 in the vicinity of the door opening portion 4 of the vehicle 1 provided with the slide door 2, in the direction of width of the vehicle. The slide door 2 may be moved in such a way that the movement position of the door side marker 81 follows a target position defined by the seat side marker 82. As a result, the inside door handle 5b is disposed at the operational standby position Xw.

Specifically, in the example illustrated in FIG. 9, a light emitting element is used as one of the door side marker 81 and the seat side marker 82, and a light receiving element is used as the other. If the slide door 2 is in an open state, and it is detected that the occupant 70 sits at the seat 60 in the vicinity of the door opening portion 4, the door ECU 20 is configured to move the slide door 2 to a position at which the door side marker 81 and the seat side marker 82 face each other.

That is, the movement position of the slide door 2 at which the door side marker 81 and the seat side marker 82 face each other is determined such that the inside door handle 5b is disposed at the predetermined position X1 which is preset between the front end position Xf and the rear end position Xr of the sitting surface 60s of the seat 60 in the vicinity of the door opening portion 4. Accordingly, without direct detection of the seat position Xs, it is possible to move the slide door 2 such that the inside door handle 5b is disposed at the operational standby position Xw.

The door side marker 81 and the seat side marker 82 may not necessarily be an optical type, and alternatively, may be a radio-wave type or a capacitance type. The following of the target position by the movement position may be detected by contact between the door side marker 81 and the seat side marker 82. The target position defined by the seat side marker 82 may not necessarily be a position at which the door side marker 81 faces the seat side marker 82. If the aforementioned configuration is adopted, even if means for detecting the slide position Px is not provided, for example, even if a seat slide apparatus provided in the seat 61 is a manual type, a small number of additional configuration elements allow the inside door handle 5b to be disposed at a position to which the occupant 70 sitting at the seat 60 in the vicinity of the door opening portion 4 easily stretches the hand.

In the embodiment, if the slide door 2 is in an open state, and it is detected that the occupant 70 sits at the seat 60 in the vicinity of the door opening portion 4, the slide door 2 is moved forward from the fully open position Xo. However, this disclosure is not limited to that configuration. Even if the seat position Xs in the vicinity of the door opening portion 4 at which the occupant 70 sits is changed in a state where the inside door handle 5b is disposed at the operational standby position Xw, the slide door 2 may be moved such that the inside door handle 5b is disposed at the operational standby position Xw corresponding to the changed seat position Xs. That is, in this case, the door ECU 20 serves as a re-movement control unit.

For example, as illustrated in the flowchart of FIG. 10, if the inside door handle 5b is disposed at the operational standby position Xw (Step S501: YES), it is determined whether the seat position Xs in the vicinity of the door opening portion 4 at which the occupant 70 sits has been changed (Step S502). If it is detected that the seat position Xs has been changed (Step S502: YES), the operational standby position Xw corresponding to the changed seat position Xs is reset based on the changed seat position Xs (Step S503). The slide door 2 may be moved such that the inside door handle 5b is disposed at the reset operational standby position Xw (Step S504).

If such a configuration is adopted, even if the occupant 70 changes the seat position Xs, it is possible to re-dispose the inside door handle 5b at a position to which the occupant 70 easily stretches the hand. Accordingly, the occupant 70 can more easily operate the slide door 2. Such re-movement control for the slide door 2 may be only executed in a case where the set operational standby position Xw has been moved forward. The re-movement control for the slide door 2 may be not performed.

If the occupant 70 sitting at the seat 60 in the vicinity of the door opening portion 4 intends to operate the slide door 2, an operation posture of the occupant 70 is detected. In this case, the door ECU 20 serving as a fully closing control unit may automatically move the slide door 2 to a fully closed position Xc (refer to FIG. 2).

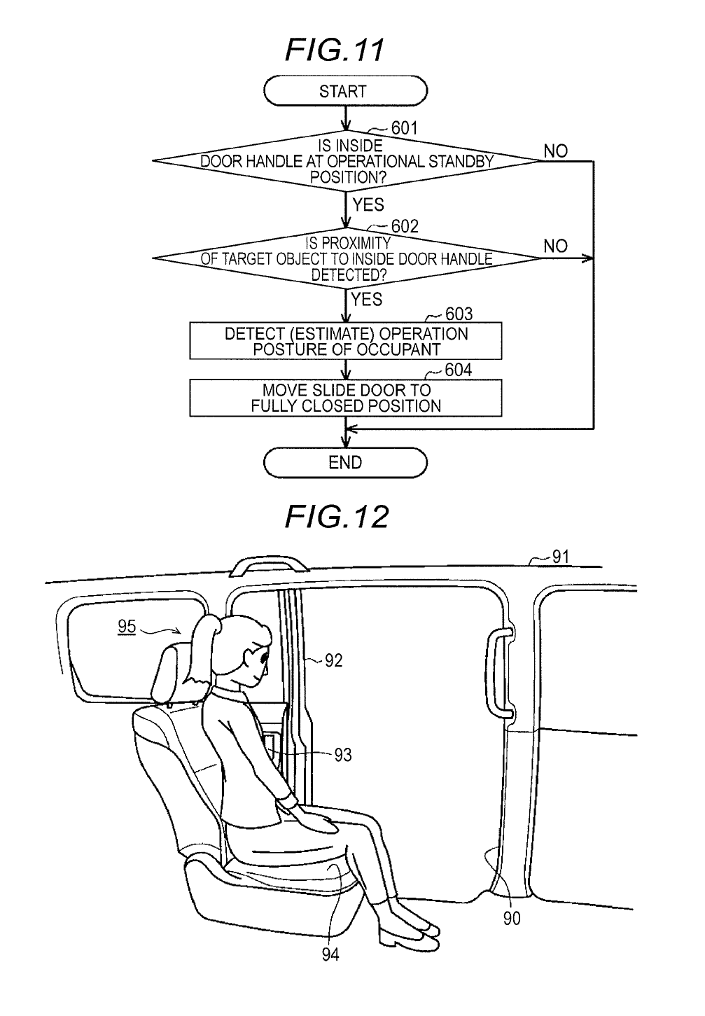

For example, as illustrated in the flowchart of FIG. 11, if the inside door handle 5b is present at the operational standby position Xw (Step S601: YES), a proximity sensor 83 (refer to FIG. 9) provided in the vicinity of the inside door handle 5b detects proximity of a detection target, that is, detects the hand of the occupant 70 stretched to the inside door handle 5b (Step S602). If proximity of a detection target to the inside door handle 5b is detected (Step S602: YES), it is estimated that the occupant 70 has taken a posture to operate the slide door 2 (Step S603). The slide door 2 may be moved to the fully closed position Xc based on detection (estimation) of the operation posture (Step S604).

It is possible to improve convenience by adopting such a configuration. The detecting of an operation posture of the occupant 70 to operate the slide door 2 may be arbitrarily changed, for example, an operation posture may be detected via image analysis using a camera. In this case, an operation estimation unit may not necessarily be the door ECU 20.

The seat 61 forming the seat 60 in the vicinity of the door opening portion 4 of the vehicle 1 provided with the slide door 2 may not necessarily be an independent seat. That is, this disclosure may be applied to a vehicle having a configuration in which one seat forms multiple seats arranged in the direction of width of the vehicle, for example, to a vehicle including a bench seat or a dividable seat.

Hereinafter, technical concepts which can be ascertained from the embodiment will be described together with effects.

(1) A method of controlling a slide door includes moving the slide door in which the movement position of a door side marker provided on a slide door side follows a target position defined by a seat side marker provided on a seat side.

In this configuration, even if means for detecting the slide position is not provided, for example, even if a seat slide apparatus is a manual type, a small number of additional configuration elements allow an inside door handle to be disposed at a position to which an occupant sitting at a seat in the vicinity of a door opening portion easily stretches the hand.

(2) The vehicle slide door apparatus further includes a center-of-gravity detection unit configured to detect a position of the center of gravity of the occupant sitting at the seat in the vicinity of the door opening portion. The operational standby position is set based on the position of the center of gravity.

(3) The vehicle slide door apparatus further includes a physique detection unit configured to detect the physique of the occupant sitting at the seat in the vicinity of the door opening portion; and an operational standby position correction unit configured to correct the operational standby position for the door handle to be disposed at a position which is moved forward to the extent that the physique of the occupant is large.

(4) The vehicle slide door apparatus further includes a re-movement control unit configured to move the slide door such that the door handle is disposed at the operational standby position corresponding to a changed position of the seat, if the position of the seat is changed in a state where the door handle is disposed at the operational standby position.

(5) The vehicle slide door apparatus further includes an operation estimation unit configured to estimate that the occupant intends to operate the slide door; and a fully closing control unit configured to move the slide door to a fully closed position if it is estimated that the occupant intends to operate the slide door in a state where the door handle is disposed at the operational standby position.

It is preferable that a method of controlling a slide door according to an aspect of this disclosure includes: detecting that a slide door of a vehicle is in an open state; detecting that an occupant sits at a seat in the vicinity of a door opening portion of the vehicle provided with the slide door; and moving the slide door such that a door handle provided in the slide door on a passenger compartment side of the vehicle is disposed at an operational standby position which is set to be located forward of a rear end position of a sitting surface of the seat in the vicinity of the door opening portion, if the slide door is in an open state, and the occupant sits at the seat in the vicinity of the door opening portion.

According to this configuration, it is possible to dispose the door handle of the slide door forward of the upper body of the occupant sitting at the seat in the vicinity of the door opening portion. As a result, the occupant can stretch the hand to the door handle without twisting the upper body. Accordingly, the occupant can easily operate the slide door.

In the method of controlling a slide door, it is preferable that the operational standby position is set to be located rearward of a front end position of the sitting surface.

According to this configuration, the occupant sitting at the seat in the vicinity of the door opening portion can easily operate the slide door while maintaining a sitting posture.

It is preferable that the method of controlling a slide door further includes detecting a position of the center of gravity of the occupant sitting at the seat in the vicinity of the door opening portion, and the operational standby position is set based on the position of the center of gravity.

That is, it is possible to estimate the position of the door handle to which the occupant sitting at the seat in the vicinity of the door opening portion easily stretches the hand, based on the detected position of the center of gravity. If the operational standby position is set to the estimated position, the occupant can more easily operate the slide door.

In the method of controlling a slide door, it is preferable that the position of the center of gravity is detected based on a distribution of loads applied to the sitting surface of the seat in the vicinity of the door opening portion.

It is preferable that the method of controlling a slide door further includes detecting the physique of the occupant sitting at the seat in the vicinity of the door opening portion; and correcting the operational standby position for the door handle to be disposed at a position which is moved forward to the extent that the physique of the occupant is large.

According to this configuration, in correspondence with the physique of the occupant, it is possible to dispose the door handle at a position to which the occupant more easily stretches the hand. As a result, the occupant can more easily operate the slide door.

It is preferable that the method of controlling a slide door further includes moving the slide door such that the door handle is disposed at the operational standby position corresponding to a changed position of the seat, if the position of the seat is changed.

According to this configuration, even if the occupant changes the seat position, it is possible to re-dispose the door handle at a position to which the occupant easily stretches the hand. Accordingly, the occupant can more easily operate the slide door.

In the method of controlling a slide door, it is preferable that, when the slide door is moved, a first marker provided on a seat side follows a second marker provided on a slide door side.

It is preferable that the method of controlling a slide door further includes estimating that the occupant intends to operate the slide door; and moving the slide door to a fully closed position if it is estimated that the occupant intends to operate the slide door in a state where the door handle is disposed at the operational standby position.

According to this configuration, it is possible to improve convenience.

In the method of controlling a slide door, it is preferable that, if proximity of a target object to the door handle is detected, it is estimated that the occupant intends to operate the slide door.

It is preferable that a vehicle slide door apparatus according to another aspect of this disclosure includes: a door open state detection unit configured to detect that a slide door of a vehicle is in an open state; a sitting detection unit configured to detect that an occupant sits at a seat in the vicinity of a door opening portion of the vehicle provided with the slide door; and a movement control unit configured to move the slide door such that a door handle provided in the slide door on a passenger compartment side of the vehicle is disposed at an operational standby position which is set to be located forward of a rear end position of a sitting surface of the seat in the vicinity of the door opening portion, if the slide door is in an open state, and the occupant sits at the seat in the vicinity of the door opening portion.

It is preferable that the vehicle slide door apparatus further includes a center-of-gravity detection unit configured to detect a position of the center of gravity of the occupant sitting at the seat in the vicinity of the door opening portion, and the operational standby position is set based on the position of the center of gravity.

It is preferable that the vehicle slide door apparatus further includes a physique detection unit configured to detect the physique of the occupant sitting at the seat in the vicinity of the door opening portion; and an operational standby position correction unit configured to correct the operational standby position for the door handle to be disposed at a position which is moved forward to the extent that the physique of the occupant is large.

It is preferable that the vehicle slide door apparatus further includes a re-movement control unit configured to move the slide door such that the door handle is disposed at the operational standby position corresponding to a changed position of the seat, if the position of the seat is changed.

It is preferable that the vehicle slide door apparatus further includes an operation estimation unit configured to estimate that the occupant intends to operate the slide door; and a fully closing control unit configured to move the slide door to a fully closed position if it is estimated that the occupant intends to operate the slide door in a state where the door handle is disposed at the operational standby position.

According to the aspects of this disclosure, the occupant sitting at the seat in the vicinity of the door opening portion can easily operate the slide door.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A method of controlling a slide door, the method comprising:
detecting that a slide door of a vehicle is in an open state;
detecting that an occupant sits at a seat in the vicinity of a door opening portion of the vehicle provided with the slide door; and
moving the slide door such that a door handle provided in the slide door on a passenger compartment side of the vehicle is disposed at an operational standby position which is set to be located forward of a rear end position of a sitting surface of the seat in the vicinity of the door opening portion, if the slide door is in an open state, and the occupant sits at the seat in the vicinity of the door opening portion.

2. The method of controlling a slide door according to claim 1,
wherein the operational standby position is set to be located rearward of a front end position of the sitting surface.

3. The method of controlling a slide door according to claim 1, further comprising:
detecting a position of the center of gravity of the occupant sitting at the seat in the vicinity of the door opening portion,
wherein the operational standby position is set based on the position of the center of gravity.

4. The method of controlling a slide door according to claim 3,
wherein the position of the center of gravity is detected based on a distribution of loads applied to the sitting surface of the seat in the vicinity of the door opening portion.

5. The method of controlling a slide door according to claim 1, further comprising:
detecting the physique of the occupant sitting at the seat in the vicinity of the door opening portion; and
correcting the operational standby position for the door handle to be disposed at a position which is moved forward to the extent that the physique of the occupant is large.

6. The method of controlling a slide door according to claim 1, further comprising:
moving the slide door such that the door handle is disposed at the operational standby position corresponding to a changed position of the seat, if the position of the seat is changed.

7. The method of controlling a slide door according to claim 6,
wherein when the slide door is moved, a first marker provided on a seat side follows a second marker provided on a slide door side.

8. The method of controlling a slide door according to claim 1, further comprising:
estimating that the occupant intends to operate the slide door; and
moving the slide door to a fully closed position if it is estimated that the occupant intends to operate the slide door in a state where the door handle is disposed at the operational standby position.

9. The method of controlling a slide door according to claim 8,
wherein if proximity of a target object to the door handle is detected, it is estimated that the occupant intends to operate the slide door.

10. A vehicle slide door apparatus comprising:
a door open state detection unit configured to detect that a slide door of a vehicle is in an open state;
a sitting detection unit configured to detect that an occupant sits at a seat in the vicinity of a door opening portion of the vehicle provided with the slide door; and
a movement control unit configured to move the slide door such that a door handle provided in the slide door on a passenger compartment side of the vehicle is disposed at an operational standby position which is set to be located forward of a rear end position of a sitting surface of the seat in the vicinity of the door opening portion, if the slide door is in an open state, and the occupant sits at the seat in the vicinity of the door opening portion.

11. The vehicle slide door apparatus according to claim 10, further comprising:
a center-of-gravity detection unit configured to detect a position of the center of gravity of the occupant sitting at the seat in the vicinity of the door opening portion,
wherein the operational standby position is set based on the position of the center of gravity.

12. The vehicle slide door apparatus according to claim 10, further comprising:
a physique detection unit configured to detect the physique of the occupant sitting at the seat in the vicinity of the door opening portion; and
an operational standby position correction unit configured to correct the operational standby position for the door handle to be disposed at a position which is moved forward to the extent that the physique of the occupant is large.

13. The vehicle slide door apparatus according to claim 10, further comprising:
a re-movement control unit configured to move the slide door such that the door handle is disposed at the operational standby position corresponding to a changed position of the seat, if the position of the seat is changed.

14. The vehicle slide door apparatus according to claim 10, further comprising:
an operation estimation unit configured to estimate that the occupant intends to operate the slide door; and
a fully closing control unit configured to move the slide door to a fully closed position if it is estimated that the occupant intends to operate the slide door in a state where the door handle is disposed at the operational standby position.
